(19) United States
(12) Patent Application Publication
(10) Pub. No.: US 2025/0170512 A1
(43) Pub. Date: May 29, 2025

(54) FILTER INSERT FOR A LIQUID SEPARATOR AND LIQUID SEPARATOR

(71) Applicant: MANN+HUMMEL GmbH, Ludwigsburg (DE)

(72) Inventors: Mohan BANGALORE PANNEERSELVAM, Speyer (DE); Klemens DWORATZEK, Edingen (DE); Frank VOGT, Hanhofen (DE); Alexander KÜHN, Römerberg (DE); Volker KRÜGER, Leimen (DE)

(21) Appl. No.: 18/959,989

(22) Filed: Nov. 26, 2024

(30) Foreign Application Priority Data
Nov. 28, 2023 (DE) 102023133188.4

(51) Int. Cl. B01D 46/00; B01D 46/24

(52) U.S. Cl. CPC B01D 46/003; B01D 46/2403; B01D 2265/04; B01D 2271/027; B01D 2273/28

(57) ABSTRACT

A filter insert for installation in a housing has a hollow-cylindrical separation element for separating liquid or aerosol from a gas flow by coalescence. The separation element has a central cutout. An annular disk-shaped flange is arranged at an end face of the separation element at the central cutout and can be arranged between a housing cover and a cylindrical housing body of the housing. A seal element is arranged at an end face of the flange so as to be oriented toward a radially inner side of the flange. The seal element, when the filter insert is in use as intended, is arranged between the flange and the housing cover and seals a raw side of the separation element in relation to a clean side of the separation element. A liquid separator provided with such a filter insert is used to separate oil from compressed air.

### CROSS-REFERENCE TO RELATED APPLICATIONS

This patent application claims the priority of the German patent application with the Ser. No. 10/202,3133188.4 which was filed on Nov. 28, 2023, in the German Patent and Trademark Office and whose contents is hereby incorporated by reference.

### BACKGROUND OF THE INVENTION

The invention concerns a filter insert for installation in a housing, for example in a pressure container of a liquid separator, as well as a liquid separator and a use of a filter insert in a liquid separator for oil separation from compressed air.

Liquid separators, for example, air/oil separation elements for separation of oil aerosol from air, can be used, for example, for oil separation from compressed air in compressed air systems which are supplied by an oil-lubricated connected element, for example, a compressor or a vacuum pump. Such a liquid separator comprises a filter insert configured to separate oil from air and a pressure container or pressure-resistant container of the connected element.

The air laden with oil flows through a raw air inlet into the pressure container so as to then flow through the filter insert, which comprises at least one filter element or separation element configured to separate oil from raw air, for example, a main separator or after separator, and to finally leave the housing in the cleaned state via the clean air outlet.

The filter insert functions in accordance with the coalescence principle. The at least one hollow-cylindrical separation element is configured as a hollow-cylindrical coalescer which coalesces the fine oil droplets to larger oil drops which settle due to the force of gravity in downward direction in the air/oil separation element and downstream thereof. The deposited oil drops are discharged through at least one drainage conduit or at least one drainage pipe.

DE 10 2021 100 413 A1 discloses a filter insert in which the flange of the filter insert comprises at least one guide structure in which at least one counter structure of the liquid separator, designed to be complementary to the guide structure, can engage. Guide structure and counter structure are configured in accordance with a lock-and-key principle. The guide structure of the flange is a groove-type axial projection of the flange which projects away from the end face of the separation element. This type of guide structure has the effect that the support surface of the flange can be arranged at the support region of the housing only when the guide structure and the counter structure are arranged so as to spatially match each other when the counter structure engages the guide structure.

### SUMMARY

It is an object of the invention to provide an improved filter insert for installation in a housing, for example in a pressure container of a liquid separator.

A further object of the invention is to provide a liquid separator with an improved filter insert.

A further object of the invention is to provide a use of an improved filter insert in a liquid separator for oil separation from compressed air.

In accordance with an aspect of the invention, the aforementioned object is solved by a filter insert for installation in a housing, for example in a pressure container of a liquid separator, at least comprising: a hollow-cylindrical separation element configured to separate liquid and/or aerosol from a gas flow by means of the coalescence principle; an annular disk-shaped flange which is arranged at an end face at a central cutout of the separation element and which can be arranged between a housing cover of the housing and a cylinder-shaped housing body of the housing; and a seal element, which is present at an end face so as to be oriented toward a radially inner side of the flange and which, in use as intended, arranged between the flange and the housing cover, seals a raw side of the separation element in relation to its clean side.

According to another aspect of the invention, the further object is solved by a liquid separator at least comprising a housing, for example a pressure container, as well as the filter insert arranged in the housing.

According to another aspect of the invention, the further object is solved by a use of the filter insert in a liquid separator, for oil separation from compressed air, wherein the liquid separator is correlated with a compressed air system which is supplied by an oil-lubricated connected element, for example, by a compressor or by a vacuum pump.

Beneficial embodiments and advantages of the invention result from the additional description, and the accompanying drawings.

According to an aspect of the invention, a filter insert for installation in a housing, for example in a pressure container of a liquid separator, is proposed.

The filter insert at least comprising: a hollow-cylindrical separation element configured to separate liquid and/or aerosol from a gas flow by means of the coalescence principle; an annular disk-shaped flange which is arranged at an end face at a central cutout of the separation element and which can be arranged between a housing cover of the housing and a cylinder-shaped housing body of the housing; and a seal element, which is present at an end face so as to be oriented toward a radially inner side of the flange and which, in use as intended, arranged between the flange and the housing cover, seals a raw side of the separation element in relation to its clean side.

The proposed filter insert represents, for example, an oil separation element in a compressor application. Such liquid separators have usually a bypass valve as a safety feature at the raw side of the liquid separator. When reaching a critical pressure differential, the bypass valve is opened. The clean side of the proposed liquid separator can be sealed effectively in relation to the raw side by means of the seal element arranged at the flange of the filter insert because the seal element is arranged radially inwardly in relation to the bypass valve at the filter insert.

In the proposed filter insert, the seal element can be advantageously pre-mounted at the flange of the filter insert.

The shape of the seal element-the shape, for example, can be Z-shaped in longitudinal section-is designed for simple mounting without the functionality of the seal element being impaired.

Beneficially, a cost-intensive processing of the housing cover, in which in accordance with the prior art usually trapezoidal slots for attachment of O-rings as a seal are introduced, can be dispensed with in this way.

Servicing can be carried out more easily and less expensively because a complex exchange of an O-ring in the housing cover can be dispensed with. The seal element which is arranged at the flange of the filter insert is exchanged together with the exchange of the filter insert.

The filter insert with the seal element arranged at the flange can also be used in existing compressors which are provided with an O-ring seal and is thus backward compatible.

The seal element can be made, for example, from fluoro-rubber monomer (FKM). Alternatively, other elastomers are also suitable as the seal element material.

According to a beneficial embodiment of the filter insert, the flange can be configured in a stair shape in longitudinal section and can comprise at least two steps adjoining each other stair-like and extending into the interior of the separation element and each comprising an axially extending region and a radially extending region. The axially extending region of the radially innermost step can rest against the central cutout of the hollow-cylindrical separation element and the radially extending region of the radially innermost step can cover an end face of the separation element. In this context, the seal element can be arranged at a step which adjoins the radially innermost step, wherein the seal element comprises a radially outwardly oriented seal lip and an annular body adjoining it and oriented in axial direction. Due to the step-like configuration of the flange, a central mounting of the flange at the cutout of the separation element as well as a central mounting of the filter insert with the flange in the housing body can be carried out in a simple manner. The annular body of the seal element imparts to the seal element sufficient stiffness for ease of handling. The seal lip is provided for sealing in relation to the housing cover.

According to a beneficial embodiment of the filter insert, the annular body, in use as intended, can rest on the radially extending region of the innermost step and can rest, at the radially inner side, against the axially extending region of the step which adjoins the radially innermost step. In this context, the seal lip can rest on the radially extending region of the step of the flange which adjoins the radially innermost step. The seal element can thus be mounted easily on the flange. The annular body of the seal element imparts to the seal element sufficient stiffness for ease of handling. The seal lip is provided for sealing in relation to the housing cover when the filter insert is inserted in the housing body and the housing is closed off by the housing cover.

According to a beneficial embodiment of the filter insert, the seal element can be clamped or glued or injection molded at the flange. In this manner, the seal element can be arranged captively at the flange. In this way, the flange with the seal element can be mounted reliably at the separation element. Also, handling of the seal element is simplified with the flange.

According to a beneficial embodiment of the filter insert, the flange can be pressed or glued into the central cutout of the separation element. For example, in this context the axially extending region of the innermost step of the flange and/or the radially extending region of the innermost step can be pressed against or glued to the central cutout and/or the end face of the separation element. In this manner, the flange with the seal element can be captively arranged at the separation element.

According to a beneficial embodiment of the filter insert, the flange can comprise at least at its radially outer rim a support surface which is configured to rest on an upper support region of the housing body which is facing the housing cover. The support surface can be correlated with the radially extending region of the step adjoining the radially innermost step. In this context, at the support surface of the flange an additional seal element can be arranged in such a way that, in use as intended, it is arranged between the flange and the housing of the liquid separator and seals the housing in relation to ambient pressure. In this way, a safe operation of the liquid separator even at higher fluid pressures can be ensured.

According to a beneficial embodiment of the filter insert, the additional seal element can comprise a circumferentially extending seal body which radially projects past an outer rim of the flange and at which a seal element protrusion extending in axial direction is arranged. In this context, the seal element protrusion, in use as intended, can engage a groove arranged so as to extend circumferentially in a seal surface of the housing body. In this way, a safe operation of the liquid separator even at higher fluid pressures can be ensured.

According to a beneficial embodiment of the filter insert, the additional seal element can be clamped or glued or injection molded captively at the outer rim of the flange. In this manner, the additional seal element can be mounted in a simple manner reliably at its intended seal position in conjunction with the insertion of the filter insert into the housing body.

According to a further aspect of the invention, a liquid separator is proposed at least comprising a housing, for example a pressure container, as well as the filter insert arranged in the housing.

The proposed liquid separator represents, for example, an oil separator in a compressor application. Such liquid separators have usually a bypass valve as a safety feature at the raw side of the liquid separator. Upon reaching a critical pressure differential, the bypass valve is opened. The clean side of the proposed liquid separator can be sealed effectively by means of the seal element, arranged at the flange of the filter insert, in relation to the raw side because the seal element is arranged radially inwardly in relation to the bypass valve at the filter insert.

According to a beneficial embodiment of the liquid separator, the support surface of the flange can be clamped between the housing cover and the housing body in the closed state of the housing. The housing body can comprise at least one flange recess configured to receive the support surface. In this context, the radius of the flange can be smaller than the radius of the housing in such a way that, at a radially outer region adjoining the flange recess, the housing cover rests directly on the housing body. In this way, a safe operation of the liquid separator even at higher fluid pressures can be ensured.

According to a beneficial embodiment of the liquid separator, a seal surface of the housing body can comprise a circumferentially extending groove for receiving the seal element protrusion of the additional seal element. In this manner, the seal element protrusion can be reliably positioned for a beneficial sealing action and properly fulfill its additional sealing function.

According to a further aspect of the invention, a use of the filter insert in a liquid separator for oil separation from compressed air is proposed, wherein the liquid separator is correlated with a compressed air system which is supplied by an oil-lubricated connected element, for example, by a compressor or by a vacuum pump.

### BRIEF DESCRIPTION OF DRAWINGS

Further advantages result from the following description of the drawings. In the drawings, exemplary embodiments of the invention are illustrated. The drawings and the following detailed description illustrate numerous features in combination. A person of skill in the art will expediently consider the features also individually and combine them to meaningful further combinations.

FIG. 1 shows a longitudinal section of a filter insert according to an embodiment of the invention.

FIG. 2 shows an isometric view of the filter insert according to FIG. 1.

FIG. 3 shows a longitudinal section of a liquid separator with a filter insert according to an embodiment of the invention.

FIG. 4 shows a sectioned isometric view of the liquid separator according to FIG. 3.

FIG. 5 shows a detail view of a longitudinally sectioned filter insert according to an embodiment of the invention with a seal element.

FIG. 6 shows a detail view of a longitudinally sectioned filter insert according to a further embodiment of the invention with an additional seal element.

FIG. 7 shows a cross section through a seal element of a flange of the filter insert according to an embodiment of the invention.

FIG. 8 shows a detail view of a longitudinally sectioned liquid separator with a filter insert according to an embodiment of the invention.

FIG. 9 shows a detail view of a longitudinally sectioned liquid separator with the filter insert according to a further embodiment of the invention.

FIG. 10 shows a detail view of a longitudinally sectioned liquid separator with a filter insert according to a further embodiment of the invention.

### DETAILED DESCRIPTION

In the Figures, same or same-type components are identified with same reference characters. The Figures show only examples and are not to be understood as limiting.

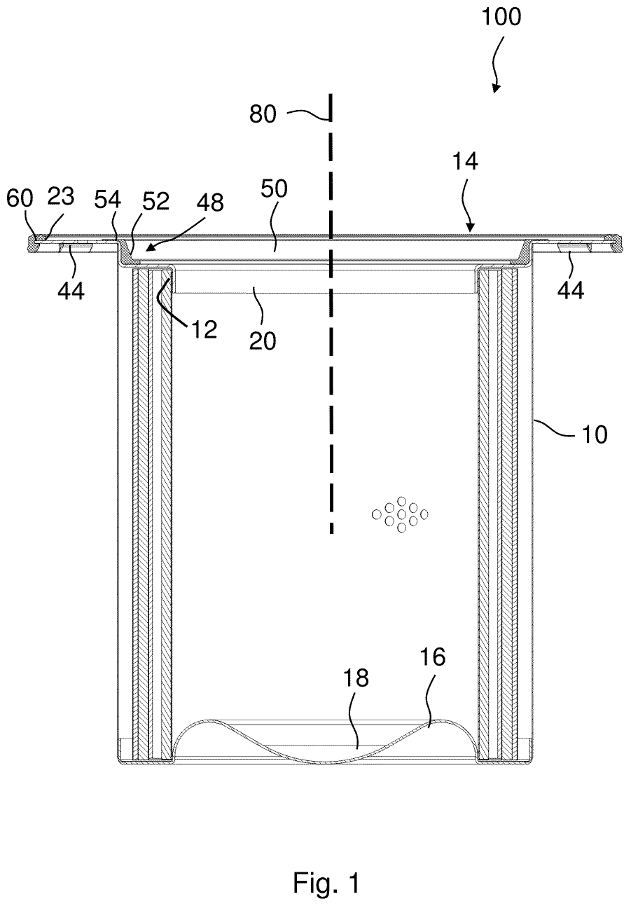

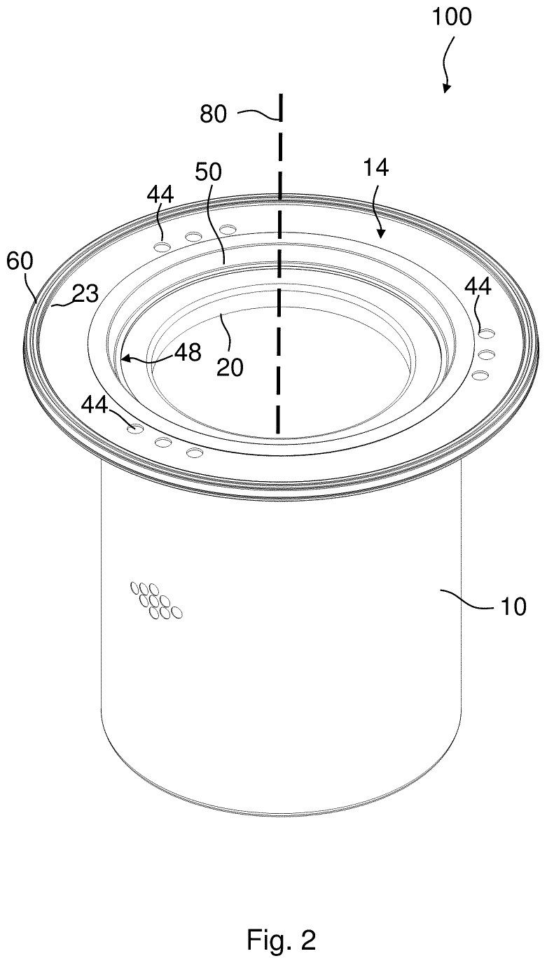

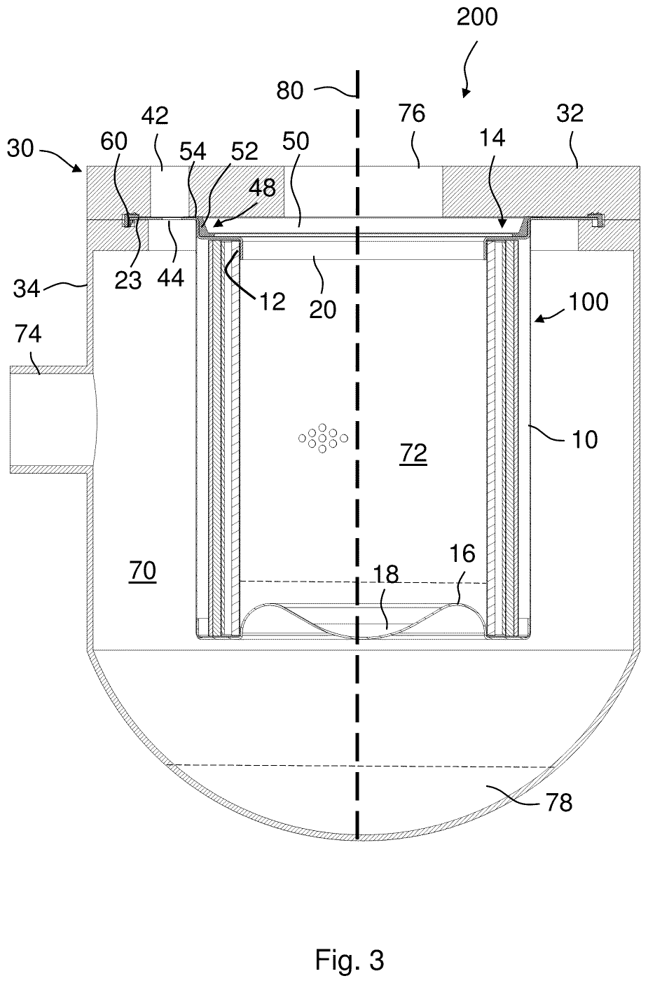

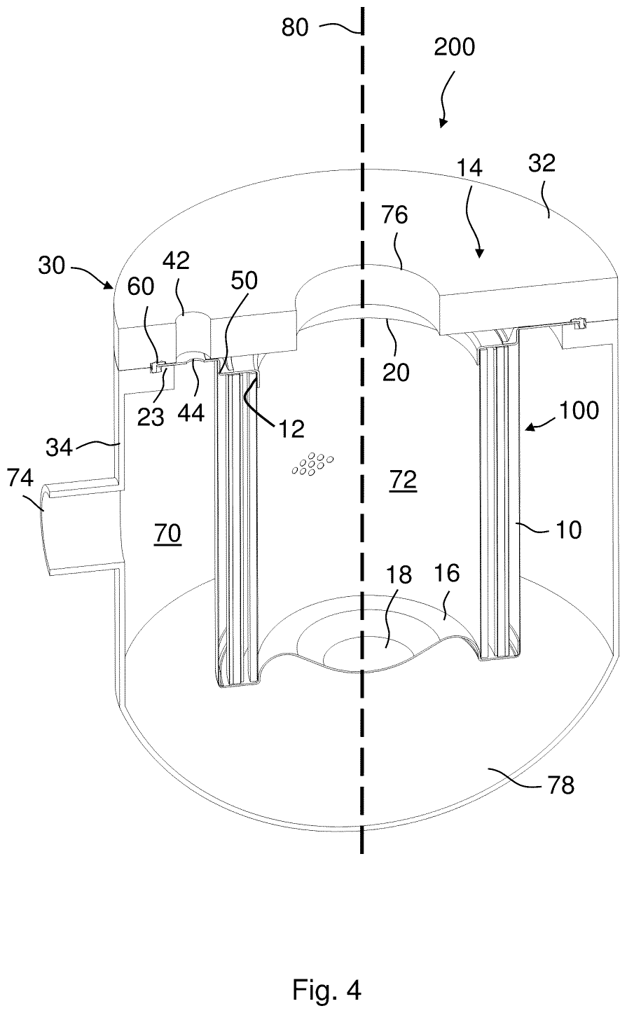

FIG. 1 shows a longitudinal section of a filter insert 100 according to an embodiment of the invention, while in FIG. 2 an isometric view of the filter insert 100 is illustrated. FIG. 3 shows a longitudinal section of a liquid separator 200 with a filter insert 100 according to an embodiment of the invention, while in FIG. 4 a sectioned isometric view of the liquid separator 200 is illustrated.

The filter insert 100 in the liquid separator 200 serves, for example, for oil separation from compressed air. The liquid separator 200 can be correlated in this context with a compressed air system which is supplied by an oil-lubricated connected element, for example, by a compressor or by a vacuum pump.

The filter insert 100 comprises a hollow-cylindrical separation element 10, configured to separate liquid and/or aerosol from a gas flow by means of the coalescence principle, as well as an annular disk-shaped flange 20 which is arranged at an end face at a central cutout 12 of the separation element 10 and which, in use as intended of the filter insert 100, is arranged in the liquid separator 200 between the housing cover 32 and the cylindrical housing body 34.

The filter insert 100 is closed off by an end disk 16 at an end of the separation element 10 opposite the end face 14. The end disk 16 is of a domed configuration and forms in its interior a liquid collecting region 18. The liquid collecting region 18 serves for accommodating liquid which has been separated by the separation element 10, for example separated oil.

The filter insert 100 is configured to have rotational symmetry with a symmetry axis 80. The housing 30 of the liquid separator 200, with the exception of attachment parts and gas supply 74 and gas discharge 76, can also be configured to have rotational symmetry.

The gas flow with the liquid to be separated and/or the aerosol passes through the gas supply 74 into the raw region of the housing 30 of the liquid separator 200 at the raw side 70 of the separation element 10 and flows through the separation element 10 into the clean region of the housing 30 at the clean side 72 of the separation element 10. In this context, liquid and/or the aerosol is separated at the body of the separation element 10 and collected in the liquid collecting region 18. A possible liquid level in the liquid collecting region 18 is indicated as a dashed line.

The purified gas leaves the housing 30 again through the cutout 12 of the separation element 10 and the gas discharge 76 in the housing cover 32. The housing body 34 comprises a liquid collecting volume 78, for example an oil collecting volume or an oil collecting space for collecting liquid, for example oil, which has been separated by preseparation, for example by gravity and/or by centrifugal force in case of tangential inflow of the raw air into the housing body 34. A possible liquid level in the liquid collecting volume 78 is indicated as a dashed line.

A seal element 50 is present at the end face 14 so as to face the radially inner side 48 of the flange 20. The seal element 50 is arranged between the flange 20 and the housing cover 32 and seals in this way the raw side 70 of the separation element 10 in relation to the clean side 72 when the housing 30 is closed.

At the radially outer rim 23, the flange 20 comprises an additional seal element 60. When the housing 30 is closed, the additional seal element 60 is arranged between the flange 20 and the housing 30 of the liquid separator 200 and seals the housing 30 in relation to ambient pressure.

The housing cover 32 comprises at least one opening 42 for insertion of a bypass valve (not illustrated). For passage of the gas flow occurring in case of the bypass valve blowing off, the flange 20 has corresponding flange openings 44 which are arranged, distributed in groups, about the circumference of the flange 20. Because the seal lip 54 of the seal element 50 is arranged radially inwardly in relation of the opening 42 for the bypass valve, the raw side 70 can be effectively sealed in relation to the clean side 72 by the seal element 50.

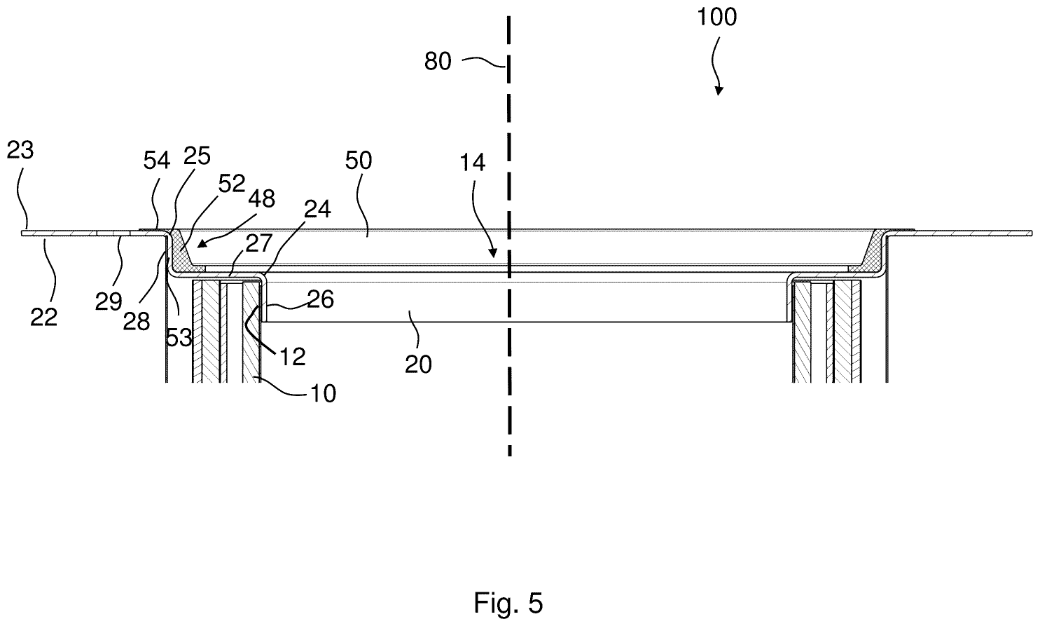

In FIG. 5, a detail view of a longitudinally sectioned filter insert 100 according to an embodiment of the invention with a seal element 50 can be seen.

The seal element 50 lies at the end face so as to face the radially inner side 48 of the flange 20. When the filter insert 100 is arranged as intended in the liquid separator 200, the seal element 50 is arranged between the flange 20 and the housing cover 32 and seals in this way the raw side 70 of the separation element 10 in relation to its clean side 72 when the housing 30 is closed.

As can be seen in the detail view in FIG. 5, the flange 20 is embodied in a stair shape in longitudinal section and comprises at least two steps 24, 25 adjoining each other stair-like and extending into the interior of the separation element 10, each comprising an axially extending region 26, 28 and a radially extending region 27, 29.

The axially extending region 26 of the radially innermost step 24 rests against the central cutout 12 of the hollow-cylindrical separation element 10. The radially extending region 27 of the radially innermost step 24 covers the end face 14 of the separation element 10.

The seal element 50 is arranged at the step 25 which adjoins the radially innermost step 24. The seal element 50 comprises a radially outwardly oriented seal lip 54 and an annular body 52 adjoining it and oriented in axial direction.

The annular body 52, when used as intended, rests on the radially extending region 27 of the innermost step 24 and rests, at the radially inner side, with its outer side 53 at the axially extending region 28 of the step 25 which adjoins the radially innermost step 24. The seal lip 54 rests on the radially extending region 29 of the step 25 of the flange 20 which adjoins the radially innermost step 24.

The flange 20 is connected to the separation element 10 in a captive manner and, for example, can be pressed or glued into the central cutout 12 of the separation element 10. For example, in this context, the axially extending region 26 of the innermost step 24 of the flange 20 and/or the radially extending region 27 of the innermost step 24 can be pressed against or glued to the central cutout 12 and/or the end face 14 of the separation element 10.

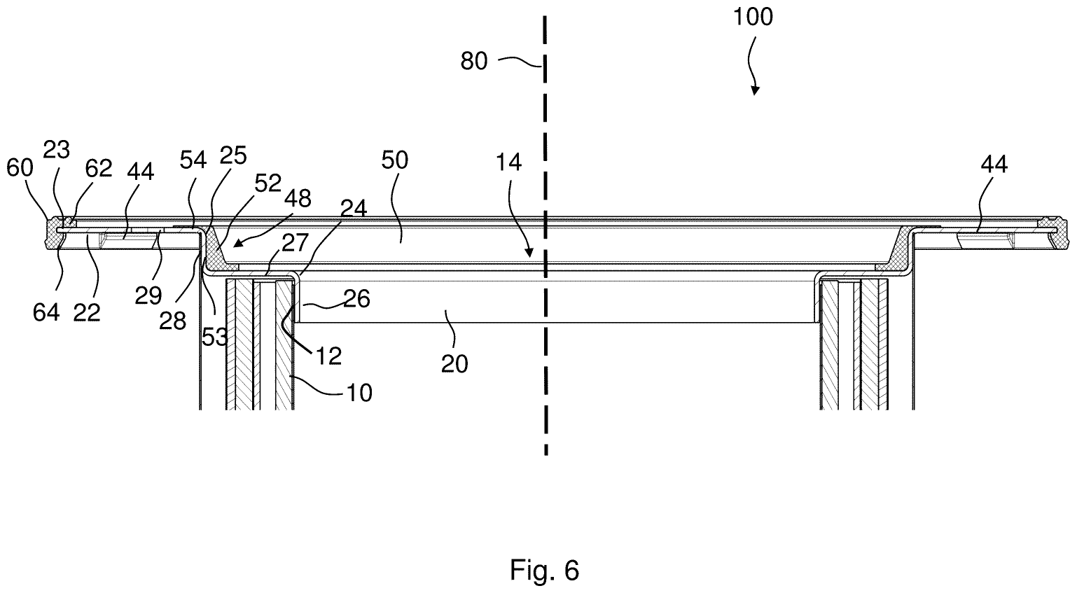

FIG. 6 shows a detail view of a longitudinally sectioned filter insert 100 according to a further embodiment of the invention with an additional seal element 60.

The flange 20 of the filter insert 100 illustrated in FIG. 6 is embodied like the flange 20 of the embodiment illustrated in FIG. 5. However, an additional seal element 60 is arranged at the flange 20 in addition to the seal element 50 and serves for sealing the housing 30 of the liquid separator 200 in relation to the environment.

The additional seal element 60 comprises a circumferentially extending seal body 62 which projects radially past the outer rim 23 of the flange 20 and at which a seal element protrusion 64 extending in axial direction is arranged.

In the longitudinal section illustrated in FIG. 6, in the support surface 22 oriented toward the outer rim 23 a flange opening 44 can be seen which serves for passage of the gas flow from the raw side 70 of the housing 30 to the clean side 72 of the separation element 10 when a bypass valve blows off.

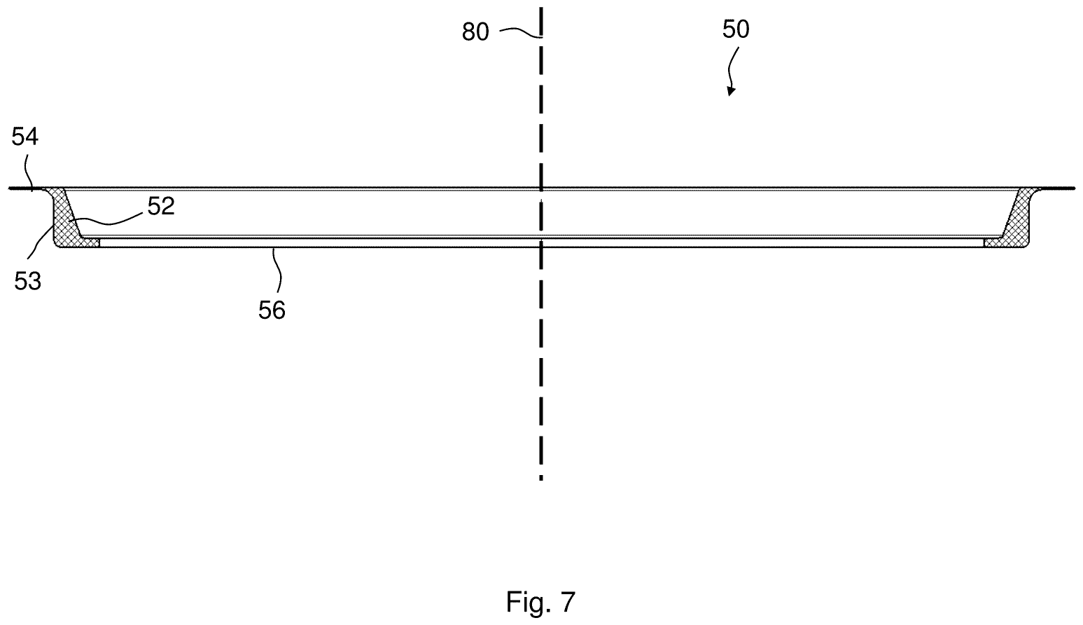

FIG. 7 shows a cross section through the seal element 50 of the flange 20. The seal element 50 is of an annular configuration and comprises a central opening 56.

The seal element 50 can be captively clamped or glued or injection molded to the flange 20, for example.

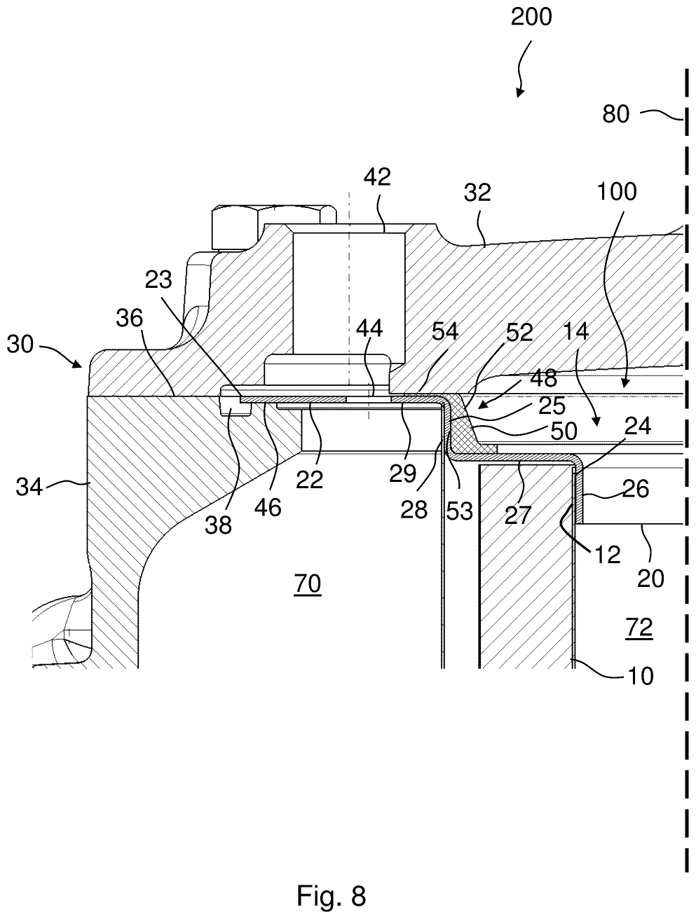

FIG. 8 shows a detail view of a longitudinally sectioned liquid separator 200 with a filter insert 100 according to an embodiment of the invention.

In the detail view, the housing 30 of the liquid separator 200, for example, a pressure container, comprising the housing body 34 and the housing cover 32 is shown only partially. A filter insert 100, also shown only partially, is mounted in the housing 30.

The housing cover 32 comprises an opening 42 for insertion of a bypass valve (not illustrated). For passage of the gas flow when the bypass valve blows off, the flange 20 comprises a flange opening 44. Since the seal lip 54 of the seal element 50 is arranged radially inwardly in relation to the opening 42 for the bypass valve, the raw side 70 can be effectively sealed in relation to the clean side 72 by the seal element 50.

Furthermore, the flange 20 comprises at its radially outer rim 23 a support surface 22 which, when the filter insert 100 is mounted, is supported on an upper support region of the housing body 34 that is facing the housing cover 32. In this context, the support surface 22 is correlated with the radially extending region 29 of the step 25 which adjoins the radially innermost step 24 and represents an extension of the radially extending region 29.

In the closed state of the housing 30, the support surface 22 of the flange 20 is clamped between the housing cover 32 and the housing body 34. The housing body 34 comprises a flange recess 46 configured to receive the support surface 22. In addition, the radius of the flange 20 is smaller than the radius of the housing 30 so that the housing cover 32 rests directly on the housing body 34 provided with the seal surface 36 at a radially outer region adjoining the flange recess 46.

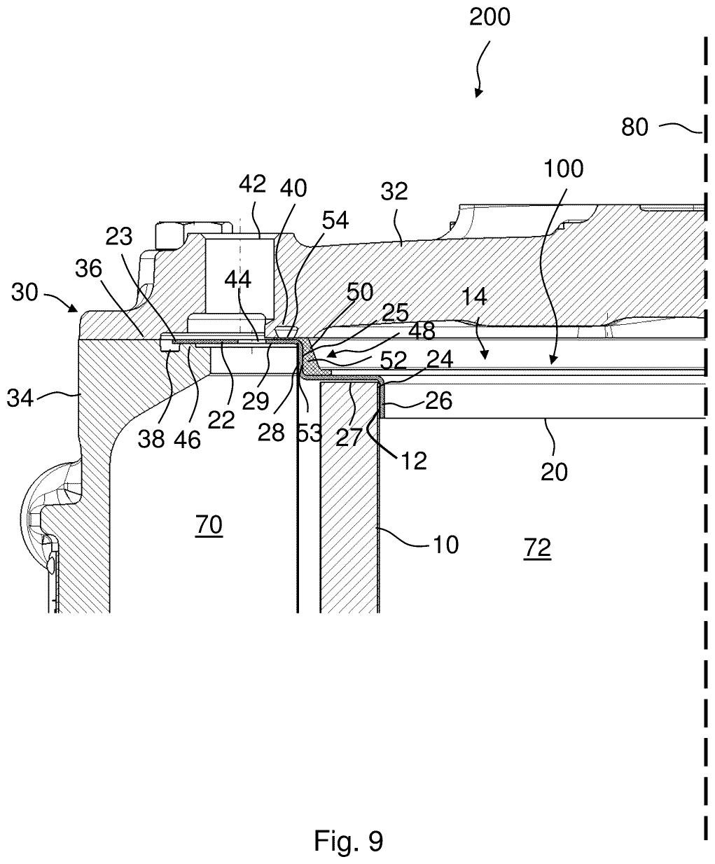

In FIG. 9, a detail view of a longitudinally sectioned liquid separator 200 with the filter insert is illustrated according to further embodiment of the invention.

The difference to the embodiment illustrated in FIG. 8 resides in that the housing cover 32 comprises a circumferentially extending groove 40 which according to the prior art can be provided for an O-ring seal between filter insert 100 and the housing cover 32 which however is no longer needed in the proposed filter insert 100 with the seal element 50 arranged at the flange 20. The seal lip 54 of the seal element 50 can seal advantageously also against such a housing cover 32 because the seal lip 54 beneficially bridges the groove 40.

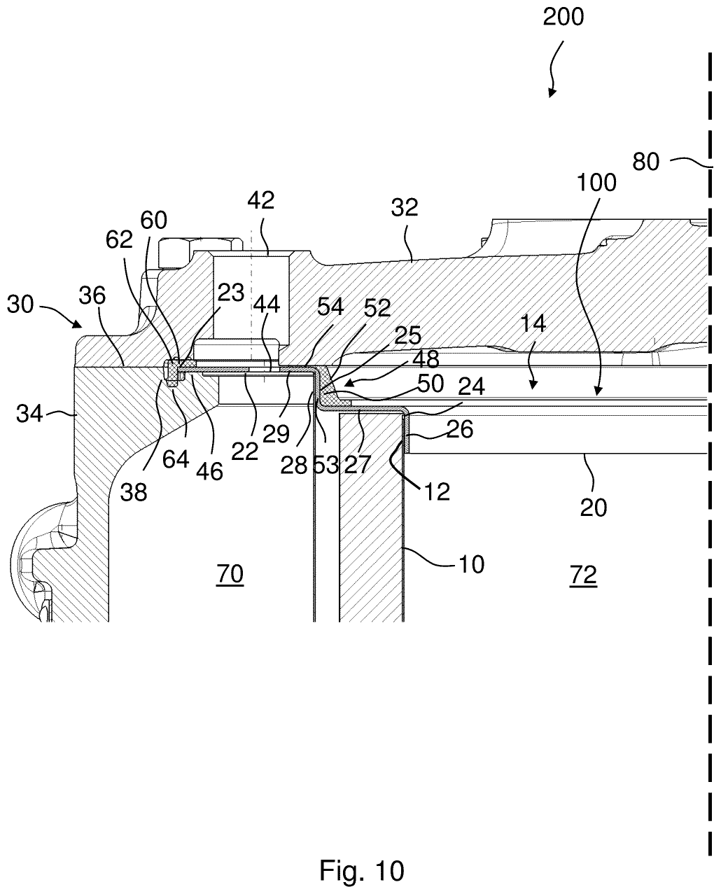

FIG. 10 shows a detail view of a longitudinally sectioned liquid separator 200 with a filter insert 100 according to a further embodiment of the invention.

In this embodiment, an additional seal element 60 is arranged at the support surface 22 of the flange 20. When the housing 30 is closed, the additional seal element 60 is arranged between the flange 20 and the housing 30 of the liquid separator 200 and seals the housing 30 in relation to the ambient pressure.

The additional seal element 60 comprises a circumferentially extending seal body 62 which radially projects past the outer rim 23 of the flange 20 and at which a seal element protrusion 64 extending in axial direction is arranged.

In this context, the seal surface 36 of the housing body 34 comprises a circumferentially extending groove 38 for receiving the seal element protrusion 64 of the additional seal element 60. The seal element protrusion 64 engages the groove 38 when the filter insert 100 is mounted. The additional seal element 60 is compressed between housing body 34 and housing cover 32 upon closing the housing 30. The seal element protrusion 64 is compressed in the groove 38. In this manner, the interior of the housing 30 is reliably sealed in relation to the environment.

The additional seal element 60 can be captively clamped or glued or injection molded at the outer rim 23 of the flange 20, for example.

### REFERENCE CHARACTERS

10 separation element
12 central cutout
14 end face
16 end disk
18 liquid collecting region
20 flange
22 support surface
23 rim
24 radially inner step
25 radially outer step
26 axially extending region of the radially innermost step
27 radially extending region of the radially innermost step
28 axially extending region of the radially outer step
29 radially extending region of the radially outer step
30 housing
32 housing cover
34 housing body
36 seal surface
38 groove
40 groove
42 opening for bypass valve
44 flange opening
46 flange recess
48 radially inner side
50 seal element
52 annular body
53 outer side
54 seal lip
56 central opening
60 additional seal element
62 seal body
64 seal element protrusion
70 raw side
72 clean side
74 raw air inlet
76 clean air outlet
78 liquid collecting volume
80 symmetry axis
100 filter insert
200 liquid separator

What is claimed is:

1. A filter insert for installation in a housing, the filter insert comprising:
a hollow-cylindrical separation element configured to separate liquid and/or aerosol from a gas flow by coalescence, the hollow-cylindrical separation element comprising a central cutout;
an annular disk-shaped flange arranged at an end face of the hollow-cylindrical separation element at the central cutout of the hollow-cylindrical separation element, wherein the annular disk-shaped flange is configured to be arranged between a housing cover of the housing and a housing body of the housing;
a first seal element arranged at an end face of the annular disk-shaped flange so as to be oriented toward a radially inner side of the annular disk-shaped flange, wherein the first seal element, when the filter insert is in use as intended, is arranged between the annular disk-shaped flange and the housing cover and seals a raw side of the hollow-cylindrical separation element in relation to a clean side of the hollow-cylindrical separation element.

2. The filter insert according to claim 1, wherein the annular disk-shaped flange, viewed in a longitudinal section, is configured in a stair shape and comprises at least two steps adjoining each other to form the stair shape, wherein the at least two steps extend into an interior of the hollow-cylindrical separation element and each comprise an axially extending region and a radially extending region;
wherein the at least two steps include a radially innermost step and a step adjoining the radially innermost step;
wherein the axially extending region of the radially innermost step rests against the central cutout of the hollow-cylindrical separation element;
wherein the radially extending region of the radially innermost step covers the end face of the hollow-cylindrical separation element;
wherein the first seal element is arranged at the step adjoining the radially innermost step, wherein the first seal element comprises a radially outwardly oriented seal lip and an axially oriented annular body adjoining the radially outwardly oriented seal lip.

3. The filter insert according to claim 2, wherein the axially oriented annular body of the first seal element, when the filter insert is in use as intended, rests on the radially extending region of the radially innermost step and rests against the axially extending region of the step adjoining the radially innermost step, wherein the seal lip rests on the radially extending region of the step adjoining the radially innermost step.

4. The filter insert according to claim 2, wherein the axially extending region of the radially innermost step is pressed against or glued to the central cutout of the hollow-cylindrical separation element.

5. The filter insert according to claim 2, wherein the radially extending region of the radially innermost step is pressed against or glued to the end face of the hollow-cylindrical separation element.

6. The filter insert according to claim 2, wherein the axially extending region of the radially innermost step is pressed against or glued to the central cutout of the hollow-cylindrical separation element and wherein the radially extending region of the radially innermost step is pressed against or glued to the end face of the hollow-cylindrical separation element.

7. The filter insert according to claim 2, wherein the annular disk-shaped flange comprises a radially outer rim, wherein at least the radially outer rim comprises a support surface configured to rest on an upper support region of the housing body, wherein the upper support region of the housing body faces the housing cover, wherein the support surface is correlated with the radially extending region of the step adjoining the radially innermost step, wherein a second seal element is arranged at the support surface such that, when the filter insert is in use as intended, the second seal element is arranged between the annular disk-shaped flange and the housing and seals the housing in relation to an ambient pressure.

8. The filter insert according to claim 7, wherein the second seal element comprises a circumferentially extending seal body projecting past the radially outer rim of the annular disk-shaped flange and further comprises an axially extending seal element protrusion arranged at the circumferentially extending seal body, wherein the axially extending seal element protrusion, when the filter insert is in use as intended, engages a groove arranged so as to extend circumferentially in a seal surface of the housing body.

9. The filter insert according to claim 8, wherein the second seal element is captively clamped or glued or injection molded to the radially outer rim of the annular disk-shaped flange.

10. The filter insert according to claim 1, wherein the first seal element is captively clamped or glued or injection molded to the annular disk-shaped flange.

11. The filter insert according to claim 1, wherein the annular disk-shaped flange is pressed or glued into the central cutout of the hollow-cylindrical separation element.

12. A liquid separator comprising a housing and a filter insert according to claim 1, wherein the filter insert is arranged in the housing.

13. The liquid separator according to claim 12, wherein the housing is a pressure container.

14. The liquid separator according to claim 12, wherein the housing comprises a housing cover and a housing body, wherein the annular disk-shaped flange of the filter insert comprises a support surface, wherein the support surface, when the housing is closed, is clamped between the housing cover and the housing body, wherein the housing body comprises at least one flange recess configured to receive the support surface, and wherein a radius of the annular disk-shaped flange is smaller than a radius of the housing such that the housing cover rests directly on the housing body at a radially outer region of the housing body adjoining the flange recess.

15. The liquid separator according to claim 14, further comprising a second seal element, wherein the second seal element comprises a seal element protrusion, wherein a seal surface of the housing body comprises a circumferentially extending groove, and wherein the seal element protrusion of the second seal element is arranged in the circumferentially extending groove.

16. The liquid separator according to claim 12, configured to separate oil from compressed air of a compressed air system supplied by an oil-lubricated connected element.

17. The liquid separator according to claim 12, configured to separate oil from compressed air of a compressed air system supplied by an oil-lubricated compressor or by an oil-lubricated vacuum pump.
